(19) United States
(12) Patent Application Publication
(10) Pub. No.: US 2025/0124519 A1
(43) Pub. Date: Apr. 17, 2025

(54) ENHANCING RELIABILITY OF TRANSACTION DATA WITHOUT THIRD-PARTY VALIDATION DATA

(71) Applicant: MASTERCARD INTERNATIONAL INCORPORATED, PURCHASE, NY (US)

(72) Inventors: Jeremy Pastore, Larchmont, NY (US); Kolli Parasuram, Kalla Mandal (IN); Raghav Datta, Pune (IN)

(21) Appl. No.: 18/486,084

(22) Filed: Oct. 12, 2023

(51) Int. Cl. G06Q 40/12

(52) U.S. Cl. CPC G06Q 40/12

(57) ABSTRACT

Examples provide estimated sector-specific transaction data with enhanced reliability using sector-specific data set(s) where validation data for the specific sector is unavailable. A regression analysis is used to generate one or more regression coefficient(s) using the validation data and data set(s) for one or more other sectors within a geographic area during a selected time-period. The regression coefficient(s) are applied to biased data sets for which validation data is unavailable to generate de-biased transaction data for the selected sector. The system produces sector-specific data with enhanced reliability and greater accuracy while reducing system resource usage where validation data for the selected sector is not available.

### BACKGROUND

When trying to capture the retail spend dynamics of an economy at a sector-level, credit card data can provide a highly informative and representative sample of spending data. However, this process of using a sample of credit data creates inherent bias in the credit-card transaction data relative to the broader retail economy. Sometimes, trusted third-party data sources, such as official government surveys of retail spending, mobility data, corporate reported sales data, and others, can be used to interpret and correct for the bias in the data. However, trusted third-party validation data is sometimes unavailable for some countries and/or retail sectors of broader retail economy, making unbiased retail data unavailable for these sectors and/or countries.

### SUMMARY

Some examples provide a system and a method for modeling retail sector spend using biased transaction data without third party validation data. A biased data manager obtains transaction data describing total retail sales completed using a credit-related payment type, such as credit card or debit card payments. The transaction data includes total retail sales across a plurality of sectors within a geographic area during a selected time-period. The transaction data includes bias associated with the credit-related payment type. The biased data manager obtains third-party validation data describing total retail sales completed using a plurality of payment types within the geographic area during the selected time-period. The third-party validation data is unbiased. A set of regression coefficients, including a slope and constant, are calculated using regression analysis. The regression coefficients define the relationship between the transaction data and the validation data. The transaction data is filtered for sector-specific transaction data describing total retail sales within a sector selected from the plurality of sectors. Sector-specific total retail sales are estimated for the selected sector using the sector-specific transaction data, a regression coefficient for slope, and a sector-specific constant in an absence of third-party validation data for the selected sector. The sector-specific constant represents a proportion of sector-specific sales relative to total retail sales across all sectors for the geographic region and selected time-period. The transaction data is updated using the estimated total retail sales for the selected sector. The bias in the transaction data for the selected sector is eliminated from the updated transaction data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for modeling retail sector spend using credit-related transaction data.

FIG. 2 is an exemplary block diagram illustrating a system including a biased data manager for generating unbiased retail sector spend data using credit-related transaction data.

FIG. 3 is an exemplary block diagram illustrating a biased data manager for generating retail sector spend using credit-related transaction data.

FIG. 4 is an exemplary flow chart illustrating operation of the computing device to generate sector-specific transaction data which is de-biased.

FIG. 5 is an exemplary flow chart illustrating operation of the computing device to update transaction data to eliminate bias without sector-specific validation data.

FIG. 6 is an exemplary flow chart illustrating operation of the computing device to obtain unbiased sector sales estimates using credit card total retail sales data.

FIG. 7 is an exemplary user interface displaying a map showing retail sales data for a grocery sector within the United States of America (USA).

FIG. 8 is an exemplary user interface displaying a map showing retail sales data for total retail excluding automotive sales by state within the USA.

FIG. 9 is an exemplary user interface displaying a map showing retail sales data for total retail excluding automotive sales by county within the USA.

FIG. 10 is an exemplary line graph showing total retail sales in the grocery sector for the nation of France.

FIG. 11 illustrates a computing apparatus according to an embodiment as a functional block diagram.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Although credit card data can provide data as to a sampling of retail spend dynamics in an economy, this data usually includes inherent bias. This bias occurs because transactions conducted using credit cards are frequently quite different with regard to types of purchases and purchase amounts than are cash purchases and purchases using other types of payment methods. Trusted third-party data may be used to compensate for this bias. Third party validation data can include official government surveys of retail spending, mobility data, corporate reported sales data, census data, etc. However, third-party validation data is sometimes unavailable for some sectors and some countries. In such cases, the biased data is unreliable and fails to accurately reflect the overall economy for all transactions associated with all payment types.

Referring to the figures, examples of the disclosure eliminate bias from credit-related transaction data for a selected sector of total retail without any sector-specific validation data available from a government or other third-party. The system removes any bias in individual sector data by using the sectors where third-party validation data is available to train a regression on those sectors, and then use some of the regression characteristics of that equation (e.g., the slope) to define the bias correction relationship for all other sectors.

In some examples, the system calculates regression coefficients, including a slope and constant, using regression analysis on the credit-related transaction data and third-party validation data for total retail sales across multiple sectors. The regression coefficients are used to de-bias the credit-related transaction data for a selected sector without having validation data for the selected sector. This eliminates bias from credit-related transaction data for each individual sector where there is no validation data available for the individual sectors.

Aspects of the disclosure further enable a biased data manager that estimates de-biased total retail sales for a selected sector using biased sector-specific transaction data, a regression coefficient, and a sector-specific constant in an absence of third-party validation data for the selected sector. The sector-specific constant represents a proportion of sector-specific sales relative to total retail sales for the plurality of sectors. This enables the elimination of bias from sector-specific total retail sales data for more accurate current retail data as well as more reliable predictions of future retail sales based on the current retail data. The de-biased data further reduces errors in retail sales forecasts while improving overall accuracy of data for individual retail sectors.

The system, in other aspects, enables de-biasing of credit card transaction data for individual retail sectors without third-party validation data for the individual retail sectors. This reduces memory resource usage as well as reducing network bandwidth usage where the user is no longer required to obtain validation data from third-party sources.

Other examples provide graphical representations of de-biased sector-specific retail sales data, including maps, graphs, charts, and other graphical representations of the data. This enables a user to quickly assess total retail sales for different sectors and geographical regions where government and other third-party validation data is unavailable. This improves user efficiency via the UI interaction and improves user performance via the UI.

In some examples, the system calculates a regression coefficient which defines a relationship between the transaction data and the validation data. The regression coefficient is calculated using regression analysis on the transaction data and the third-party validation data. The regression coefficient enables modeling of retail sector spend in an absence of third-party validation data for enhanced reliability of the predicted sector-specific total retail sales data.

In other examples, the system estimates total retail sales for a specific sector using sector-specific transaction data and the regression coefficient without sector-specific validation data thereby enhancing reliability of the estimated total retail sales where validation data is unavailable. The system further generates estimated total retail sales without obtaining sector-specific validation data via a network, thereby reducing consumption of computing resources. More specifically, the system reduces network bandwidth usage while increasing energy savings.

In other aspects, the system updates the transaction data in the data storage device with the estimated total retail sales for the selected sector without obtaining or storing third-party validation data, thereby reducing memory space required for further optimization of computing resources. The bias associated with the single payment type is also eliminated from the updated transaction data for the selected sector for reduced error rate and enhanced reliability of the updated transaction data.

The computing device operates in an unconventional manner by eliminating bias from credit card transaction data for a selected retail sector and geographic region during a selected time-period where third-party validation data is unavailable. In this manner, the computing device is used in an unconventional way, and allows a user with only credit card/debit card related transaction data obtain a reliable estimate of total retail sales in the selected sector for all payment types without third-party data, thereby improving the functioning of the underlying computing device while reducing system resource usage.

Further, aspects of the disclosure improve the usability of the transaction data and/or the underlying device at least by removing bias from the transaction data. Efficiency is also improved via display of the modeled data lacking bias, and user interaction performance is also improved via the UIs as described herein. This overall improves the human machine interaction

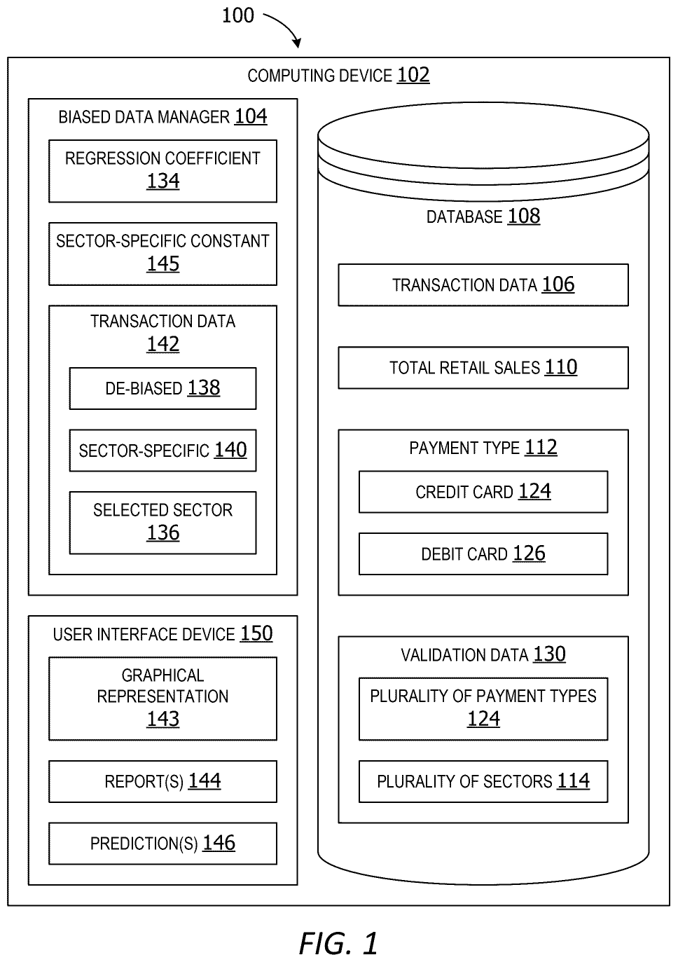

Referring again to FIG. 1, an exemplary block diagram illustrates a system 100 for modeling retail sector spend using credit-related transaction data. In the example of FIG. 1, the computing device 102 represents any type of computing device executing instructions, such as application programs, operating system functionality, or both. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the application programs include a biased data manager 104. The biased data manger 104 in some examples, stores transaction data 106 on a data store, such as, but not limited to, a database 108. The transaction data 106 is data describing total retail sales 110 completed using a single payment type 112 across a plurality of sectors 114 within a geographic area 116 during a selected time-period 118. The transaction data 106 includes inherent bias 120 due to the transaction data 106 being associated with the single payment type 112.

The payment type 112, in this example, is a credit-related 122 payment type 112. The credit-related payment type 112 includes transaction data for transactions completed using credit card 124 and/or debit card 126 payment methods. In this example, the transaction data 106 includes monthly time series data for a geographic region, such as, but not limited to, a country (e.g., nation), state, territory, county, parish, city, or any other type of geographic area.

In some examples, the biased data manager 104 obtains validation data 130 from a third-party. The third-party can include government entities as well as non-government entities. The validation data 130 describes total retail sales completed by customers using a plurality of payment types 132 within the same geographic area 116 during the same time-period 118. The third-party validation data 130 is unbiased.

In some examples, the biased data manager 104 calculates a regression coefficient 134 defining a relationship between the transaction data 106 and the validation data 130 using regression analysis. The biased data manager 104 filters the transaction data 106 for transaction data for the selected sector 136 in the plurality of sectors 114. The sector 136 is a retail sector. The total retail sales include sales within the plurality of sectors 114. The transaction data is filtered for retail sales within the selected sector while filtering out sales from other sectors.

The plurality of sectors 114 includes sectors such as, but not limited to, grocery, automotive, apparel, garden supplies, pet supplies, hardware, toys, electronics, housewares, etc. In this example, the selected sector is a grocery sector. Thus, the biased data manager filters for retail sales associated with grocery items, like bread, milk, eggs, etc. However, the examples are not limited to the grocery sector. The selected sector can include any retail sector.

The biased data manager 104 generates de-biased 138, sector-specific 140 transaction data 142. The transaction data 142 is generated using the regression coefficient 134 identified using the validation data and a sector-specific constant 145 without any validation data for the selected sector 136. The sector-specific constant 145 represents a proportion of sector-specific sales relative to total retail sales for the plurality of sectors. The sector-specific constant 145 may be referred to as a modified constant value or an adjusted constant. The sector-specific constant 145 is obtained by scaling down the regression coefficient constant in accordance with the ratio of retail sales in the selected sector 136 relative to the total retail sales in the plurality of sectors 114.

In some examples, the de-biased transaction data for the selected sector 136 is output to a user via a user interface device 150. The de-biased transaction data 142 for the selected sector 136 is presented to the user as a graphical representation 143, such as a map, graph, table, chart, or other graphical representation of sales data within a selected sector in one or more geographical areas. In other examples, the biased data manager generates one or more report(s) 144 including the de-biased transaction data 142 in textual form and/or graphical form. The report(s) can optionally include an audio component, such as audio describing the transaction data 142. In still other examples, the biased data manager 104 generates prediction(s) 146, including future retail sale forecasts, using the de-biased transaction data for one or more selected sectors.

In some examples, the biased data manager 104 provides for modelling country retail sector spend using credit card transaction data for sectors without third-party validation data. Where the system has access to a time series of credit-data representative of a given sector in one or more countries or other geographic areas and a corresponding time series of representative third-party validation data, the biased data manager 104 uses linear regression to interpret the relationship between these two different time series to eliminate bias. For situations where third-party validation data is unavailable for a selected sector 136, the biased data manager 104 uses transaction data and regression coefficient(s) to fill in these gaps in data availability.

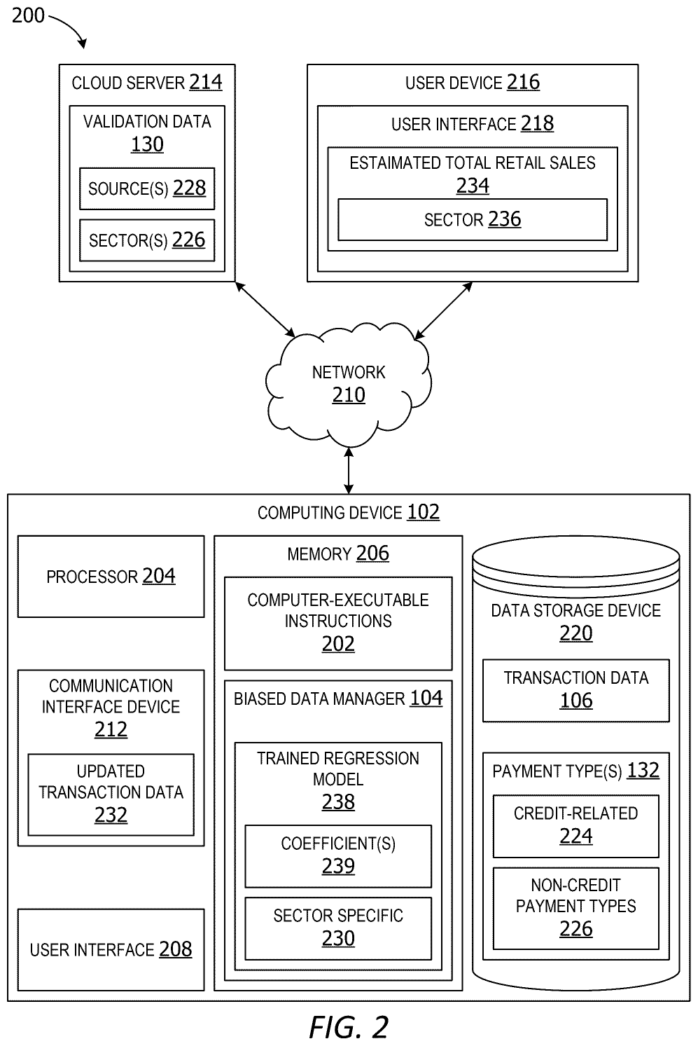

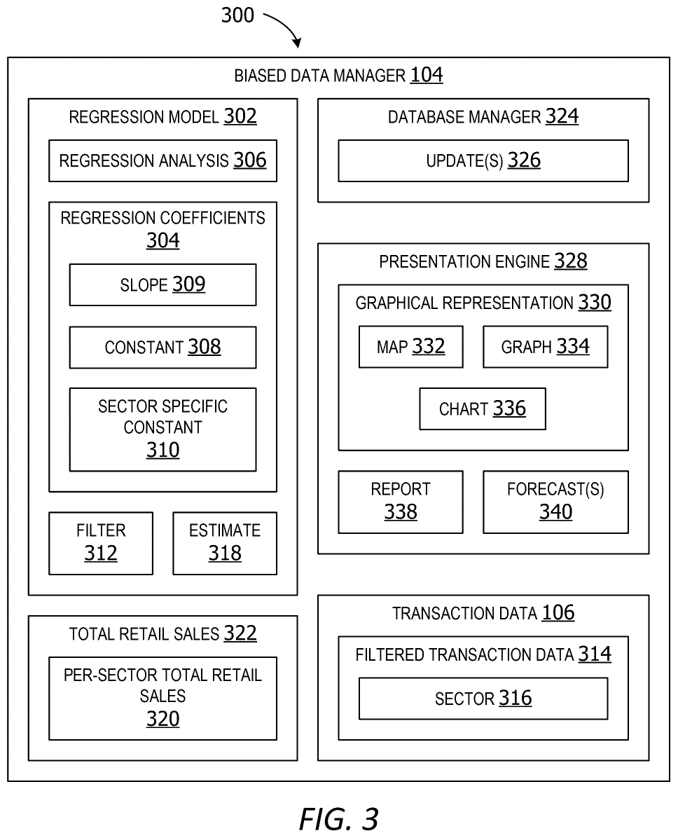

In some examples, the biased data manager 104 takes the regression coefficients, including one or more slopes, used for the overall retail spend to correct these biases in the credit card transaction data. In these examples, the regression coefficient(s) are regression model parameters for a regression model, such as, but not limited to, the trained regression model 238 in FIG. 2 and/or the regression model 302 in FIG. 3. These model parameters are used along with a scaled intercept to eliminate the biases in the sector credit-card transaction data.

The regression equation employed during the regression analysis in some examples is of the form y=mx+c. Here, c is the constant and m is the slope. Once the regression model parameters calculates these parameters for overall retail data by regressing the credit data on the third-party validation data 130, the regression model parameters utilizes the slope for the retail sectors which suffer from a lack of data availability and use a sector-specific constant c. The sector-specific constant may be referred to as a scaled constant.

The regression model parameters calculates the sector-specific constant 145 by estimating the proportion of retail that a particular sector represents. For example, if the proportion of retail transactions for a selected sector is ten percent (0.1) of the overall retail transactions for all sectors, the sector-specific constant is 0.1 or ten-percent of the regression coefficient 134 constant c calculated for total retail across all sectors. Thus, the sector-specific constant for the example where the ratio of retail sales for a selected sector is ten percent of the total retail sales for all sectors can be described as 0.1 c to find the sector-specific constant 145 which is used in the regression. As a result, the final regression equation for this sector is y=mx+0.1 c, where x is the existing credit-card sourced sector data. Given that the slope and constant are calculated based on a regression model utilizing third-party data, it eliminates any biases that may arise in the data due to it being sourced from credit/debit cards.

In another example, the system corrects the biases for total retail using third party validation data. In this non-limiting example, the regression analysis results in a constant of 100 and a slope coefficient of 0.6. To eliminate bias from other sectors, the user selects a sector from the plurality of sector, such as the grocery sector. Third-party validation data is unavailable for the grocery sector in the country in this example. Therefore, the biased data manager 104 uses the regression coefficient 134 from the total retail regression to model the grocery numbers, with some changes. The slope is borrowed from the total retail and remains 0.6. However, the constant changes to the sector-specific constant 145. If the total amount of grocery in the credit-related transaction data for the time-period being studied is 20, and the same for total retail is 200, then the new constant is calculated as 100*20/200=10. This eliminates issues associated with scaling down from total retail across all sectors to retail sales data for a single sector. Taking a constant of 100 for grocery would result in sales numbers far too high, which would not be representative of the selected sector. Hence, final regression parameters for grocery are 10 for the constant and 0.6 for the slope, in this example. The formula can be shown as:

$$Unbiased grocery sale data = 10 + ( 0.6 ) ( bias grocery sale data )$$

Hence, in this approach, the biased data manager 104 is superimposing the third-party validated overall retail spend data on the credit-card transaction trend of the retail sub-sector concerned.

FIG. 2 is an exemplary block diagram illustrating a system 200 including a biased data manager 104 for generating unbiased retail sector spend data using credit-related transaction data. In the example of FIG. 2, the computing device 102 represents any device executing computer-executable instructions 202 (e.g., as application programs, operating system functionality, or both) to implement the operations and functionality associated with the computing device 102. In some examples, the computing device 102 has at least one processor 204 and a memory 206. The computing device 102, in other examples, includes a user interface 208.

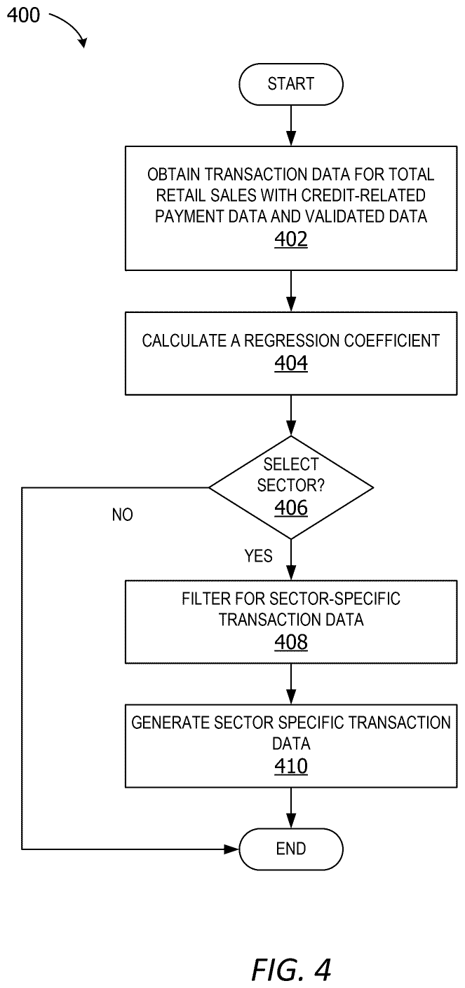

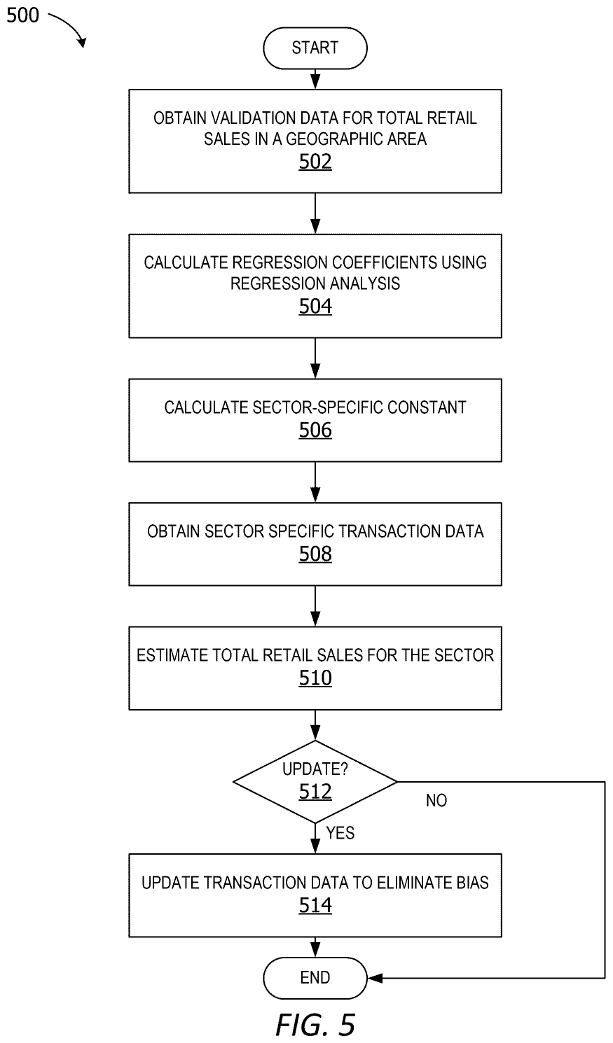

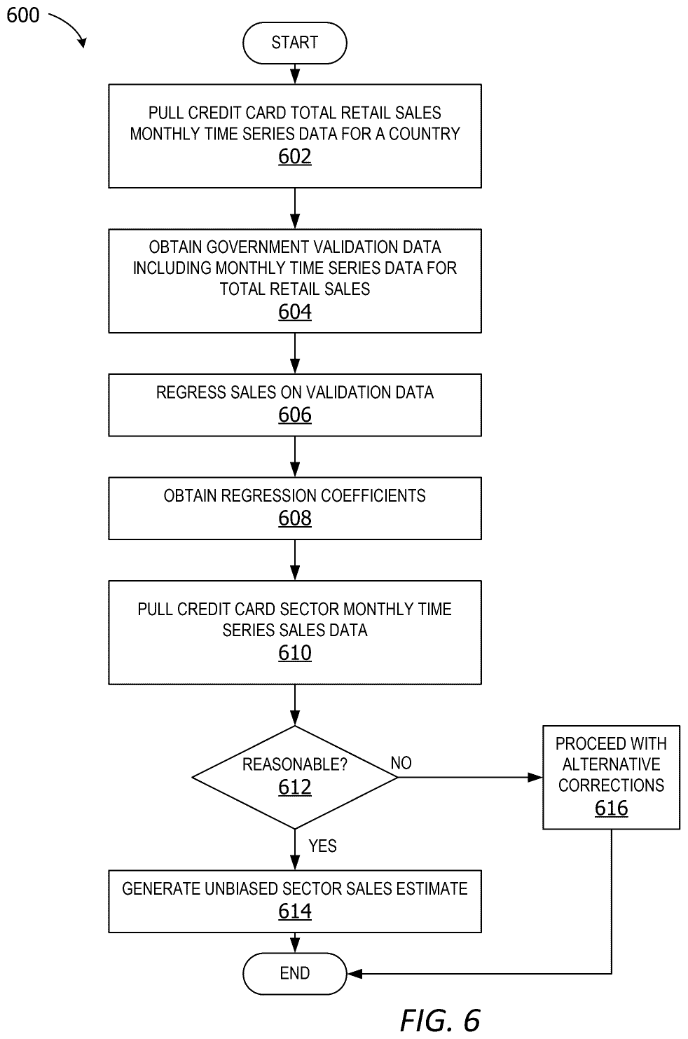

The processor 204 includes any quantity of processing units and is programmed to execute the computer-executable instructions 202. The computer-executable instructions 202 is performed by the processor 204, performed by multiple processors within the computing device 102 or performed by a processor external to the computing device 102. In some examples, the processor 204 is programmed to execute instructions such as those illustrated in the figures (e.g., FIG. 4, FIG. 5, and FIG. 6).

The computing device 102 further has one or more computer-readable media such as the memory 206. The memory 206 includes any quantity of media associated with or accessible by the computing device 102. The memory 206, in these examples, is internal to the computing device 102 (as shown in FIG. 1). In other examples, the memory 206 is external to the computing device (not shown) or both (not shown).

The memory 206 stores data, such as one or more applications. The applications, when executed by the processor 204, operate to perform functionality on the computing device 102. The applications can communicate with counterpart applications or services such as web services accessible via a network. In an example, the applications represent downloaded client-side applications that correspond to server-side services executing in a cloud.

In other examples, the user interface component 208 includes a graphics card for displaying data to the user and receiving data from the user. The user interface component 208 may also include computer-executable instructions (e.g., a driver) for operating the graphics card. Further, the user interface component 208 may include a display (e.g., a touch screen display or natural user interface) and/or computer-executable instructions (e.g., a driver) for operating the display. The user interface component 208 may also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 210 is implemented by one or more physical network components, such as, but without limitation, routers, switches, network interface cards (NICs), and other network devices. The network 210 is any type of network for enabling communications with remote computing devices, such as, but not limited to, a local area network (LAN), a subnet, a wide area network (WAN), a wireless (Wi-Fi) network, or any other type of network. In this example, the network 210 is a WAN, such as the Internet. However, in other examples, the network 210 is a local or private LAN.

In some examples, the system 200 optionally includes a communications interface component 212. The communications interface component 212 includes a network interface card and/or computer-executable instructions (e.g., a driver) for operating the network interface card. Communication between the computing device 102 and other devices, such as but not limited to cloud server 214 and/or a user device 216, can occur using any protocol or mechanism over any wired or wireless connection. In some examples, the communications interface component 212 is operable with short range communication technologies such as by using near-field communication (NFC) tags.

The user device 216 represent any device executing computer-executable instructions. The user device 216 can be implemented as a mobile computing device, such as, but not limited to, a wearable computing device, a mobile telephone, laptop, tablet, computing pad, netbook, gaming device, and/or any other portable device. The user device 216 includes at least one processor and a memory. The user device 216 can also include a user interface 218, such as, but not limited to, the user interface device 150 in FIG. 1.

The cloud server 214 is a logical server providing services to the computing device 102 or other clients, such as, but not limited to, the user device 216. The cloud server 214 is hosted and/or delivered via the network 210. In some non-limiting examples, the cloud server 214 is associated with one or more physical servers in one or more data centers. In other examples, the cloud server 214 is associated with a distributed network of servers.

The system 200 optionally includes a data storage device 220 for storing data, such as, but not limited to validation data 130 associated with a plurality of payment types 132 and/or regression coefficient(s) 239. The plurality of payment types 132 includes a credit-related payment type 224 and/or non-credit payment types 222. The credit-related payment type 224 includes credit card payments as well as debit card payments. The credit-related payment type 222 may also include purchases completed using store credit. The non-credit payment types 222 include cash payments, payment by check, purchase using reward points, or any other non-credit related type of payment.

The data storage device 220 includes one or more different types of data storage devices, such as, for example, one or more rotating disks drives, one or more solid state drives (SSDs), and/or any other type of data storage device. The data storage device 220 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 220 includes a database, such as, but not limited to, the database 108 in FIG. 1.

The data storage device 220 in this example is included within the computing device 102, attached to the computing device, plugged into the computing device, or otherwise associated with the computing device 102. In other examples, the data storage device 220 includes a remote data storage accessed by the computing device via the network 210, such as a remote data storage device, a data storage in a remote data center, or a cloud storage.

The memory 206 in some examples stores one or more computer-executable components, such as, but not limited to, the biased data manager 104. In some examples, the biased data manager 104 obtains transaction data 106 describing total retail sales completed using a credit-related payment type 224 across a plurality of sectors 226 within a geographic area during a selected time-period. The biased data manager 104 obtains the validation data 130 from one or more third-party source(s) 228, such as, but not limited to, a government survey, census data, or other third-party retail data associated with transactions completed using a plurality of payment types 132. The third-party validation data is unbiased as the data is not limited to credit card transactions, but includes cash transactions, and other non-credit related transactions.

In some examples, the biased data manager 104 identifies one or more regression coefficient(s) 239 defining a relationship between the transaction data 106 and the validation data 130 by performing regression analysis on the transaction data and the validation data. This is accomplished in some examples by using a regression model on the data. The regression coefficient includes a slope (m) value and a constant (c) value. The transaction data 106 is filtered for sector-specific 230 transaction data 232 describing total retail sales within a sector selected from the plurality of sectors 226. The biased data manager 104 eliminates the bias from the sector-specific transaction data 232 using a trained regression model 238 on the transaction data 232. The trained model is a regression model which is trained using transaction data and validation data for a specific geographic area, sectors, and time-period. In some examples, the trained regression model 238 utilizes the regression coefficient(s) to generate updated transaction data 232 for the selected sector 236, including an estimated total retail sales 234 for the selected sector 236 based on a result of the regression analysis performed by the trained regression model.

In some examples, the trained regression model 238 is a regression model trained using the transaction data 106 and the validation data 130. The regression model uses the calculated regression coefficient(s) 239 to generate the updated transaction data 232 for a sector 236 selected from the plurality of sectors 226.

The biased data manager 104, in some examples, outputs the updated transaction data 232 to one or more user devices for presentation to a user via the network 210. In other examples, the biased data manager 104 updates a database storing biased transaction data with the updated transaction data as part of database management keeping the sales-related data accurate and reliable. In still other examples, the biased data manager 104 generates a graphical representation including the sector-specific transaction data for presentation to a user via the user interface 208 and/or the user interface 218 on the user device 216. The updated transaction data 232 in other examples is used for future retail sales forecasting and generating predictions of future sales for use in making future products purchases, stocking, promotions, etc.

Referring now to FIG. 3, an exemplary block diagram illustrates a biased data manager 104 for generating retail sector spend using credit-related transaction data 106. In some examples, the biased data manager 104 obtains single payment type transaction data 106 describing total retail sales completed using a credit-related payment type across a plurality of sectors within a geographic area during a selected time-period. The biased data manager 104 obtains third-party validation data which is used by the regression model 302 to generate a set of regression coefficients 304. The regression model becomes a trained regression model after it has been trained using specific transaction data and validation data for a selected geographic area during a specific time-period.

In some examples, the regression model 302 performs regression analysis 306 to identify the regression coefficients 304, such as slope and constant, using the transaction data and validation data for the same geographic region and the same time-period across a plurality of retail sectors. The regression coefficients 304 include a slope 309 and a constant 308.

The biased data manager 104 uses a filter 312 to filter the transaction data 106 for sector-specific transaction data describing total retail sales within a sector selected from the plurality of sectors. This filtered transaction data 314 includes sales for the selected sector 316 associated with the credit-related payment type and therefore contains inherent bias. In this example, sector-specific validation data is unavailable.

The biased data manager 104 scales down the constant 308 to reflect the ratio of the sector specific sales to the total retail sales across all sectors. This sector-specific constant 310 reflects the proportion of sector-specific sales relative to total retail sales for the plurality of sectors. The biased data manager 104 uses the sector-specific constant 308 and the slope 309 to estimate 318 per-sector total retail sales 320 for the selected sector 316 out of the total retail sales 322 for all sectors obtained from the validation data for all sectors.

In some examples, the biased data manager 104 includes a database manager 324 which performs update(s) 326 of the transaction data 106 within a database using the estimated sector-specific total retail sales 320 for the selected sector 316 to eliminate the bias from the transaction data.

In other examples, a presentation engine 328 generates a graphical representation 330 including the per-sector total retail sales 320, such as, but not limited to, a map 332, a graph 334 and/or a chart 336 presenting the de-biased transaction data to the user. In still other examples, the presentation engine 328 generates a report 338 detailing the updated transaction data and/or forecast(s) 340 of future sales using the updated transaction data.

FIG. 4 is an exemplary flow chart 400 illustrating operation of the computing device to generate sector-specific transaction data which is de-biased. The process shown in FIG. 4 is implemented by a biased data manager executing on a computing device, such as, but not limited to, the computing device 102 in FIG. 1 and FIG. 2.

The process begins with obtaining transaction data for total retail sales with credit-related payment data and validation data at 402. The biased data manager calculates a regression coefficient using the transaction data and validation data at 404. A determination is made whether a sector is selected at 406. If yes, the biased data manager is filtered for sector-specific transaction data at 408. The sector-specific transaction data is generated using the filtered transaction data and the regression coefficient at 410. The process terminates thereafter.

Turning now to FIG. 5, an exemplary flow chart 500 illustrating operation of the computing device to update transaction data to eliminate bias without sector-specific validation data is shown. The process shown in FIG. 5 is implemented by a biased data manager executing on a computing device, such as, but not limited to, the computing device 102 in FIG. 1 and FIG. 2.

The process begins by obtaining validation data for total retail sales in a geographic area at 502. Regression coefficients are calculated using regression analysis at 504. The regression coefficients include slope and constant. The biased data manager calculates a sector-specific constant at 506. The biased data manager obtains sector-specific transaction data at 508. The sector-specific transaction data is credit-related payment data filtered from the transaction data for credit-related transactions across all sectors. The biased data manager estimated total retail sales for the sector at 510. A determination is made whether to update the transaction data at 512. If yes, the transaction data is updated to eliminate bias using the estimated total retail sales for the selected sector at 514. The process terminates thereafter.

FIG. 6 is an exemplary flow chart 600 illustrating operation of the computing device to obtain unbiased sector sales estimates using credit card total retail sales data. The process shown in FIG. 6 is implemented by a biased data manager executing on a computing device, such as, but not limited to, the computing device 102 in FIG. 1 and FIG. 2.

The process begins by obtaining credit card total retail sales monthly time series data for a country at 602. The biased data manager obtains government validation data including monthly time series data for total retail sales at 604. The biased data manager regresses sales on validation data at 606. The biased data manager obtains regression coefficients at 608. The biased data manager pulls credit card sector monthly time series sales data at 610. A determination is made whether the data passes a reasonableness check at 612. If yes, the biased data manager generates unbiased sector sales estimate at 614. If it is not reasonable to proceed at 612, the system proceeds with other alternative corrections to determine sector-specific sales at 616. The process terminates thereafter.

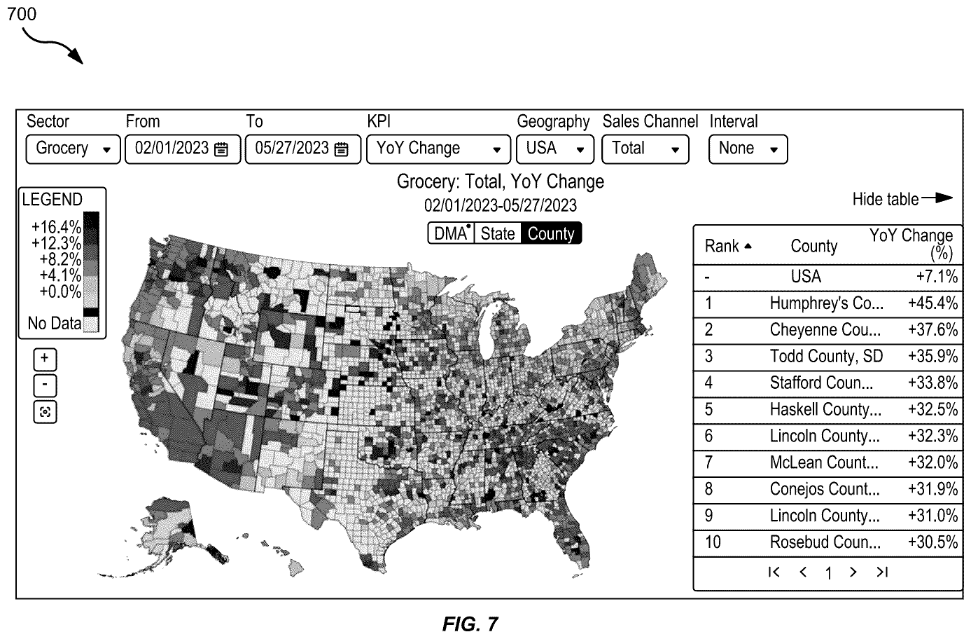

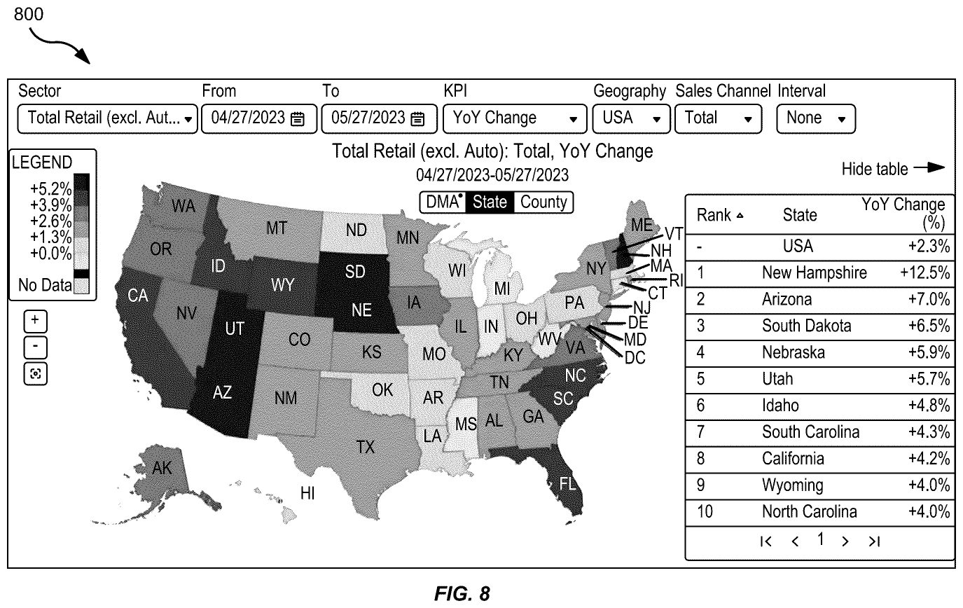

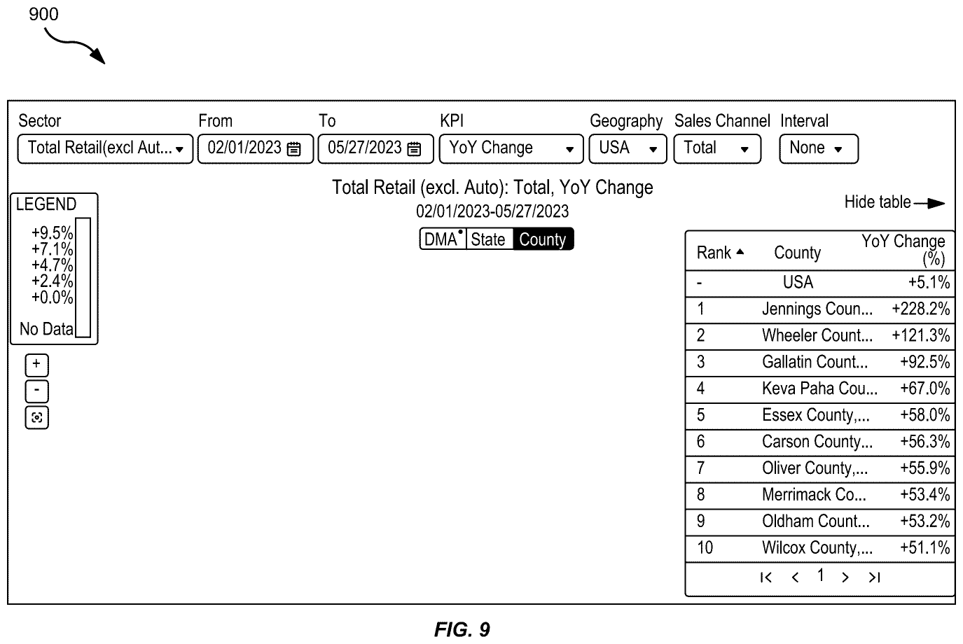

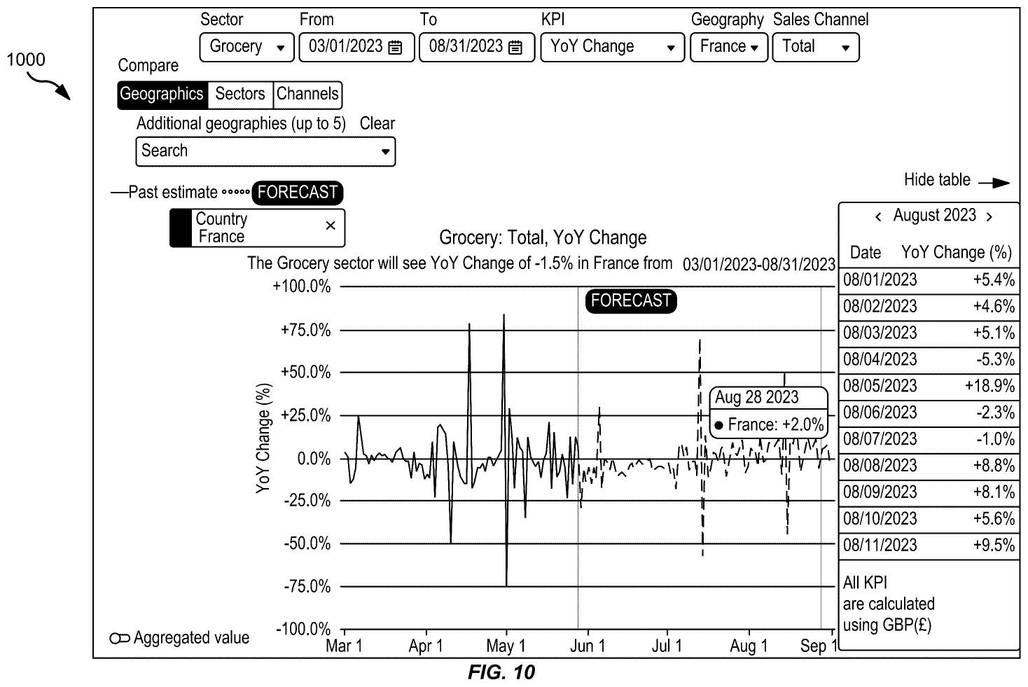

FIG. 7 is an exemplary user interface displaying a map 700 showing retail sales data for a grocery sector within the United States of America (USA). FIG. 8 is an exemplary user interface displaying a map 800 showing retail sales data for total retail excluding automotive sales by state within the USA. FIG. 9 is an exemplary user interface displaying a map 900 showing retail sales data for total retail excluding automotive sales by county within the USA. FIG. 10 is an exemplary line graph 1000 showing total retail sales in the grocery sector for the nation of France.

### Exemplary Operating Environment

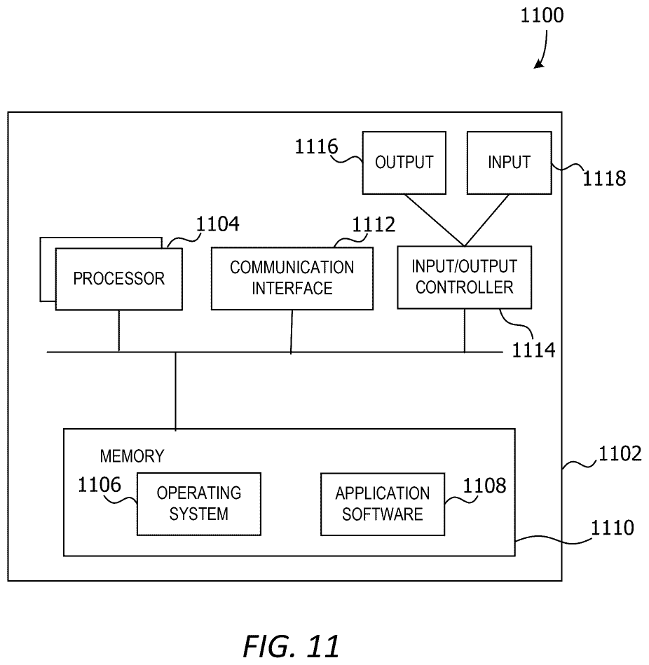

The present disclosure is operable with a computing apparatus according to an embodiment as a functional block diagram of a computing system 1100 in FIG. 11. In an embodiment, components of a computing apparatus 1102 may be implemented as a part of an electronic device according to one or more embodiments described in this specification. The computing apparatus 1102 comprises one or more processors 1104 which may be microprocessors, controllers, or any other suitable type of processors for processing computer executable instructions to control the operation of the electronic device. Alternatively, or in addition, the processor 1104 is any technology capable of executing logic or instructions, such as a hardcoded machine. Platform software comprising an operating system 1106 or any other suitable platform software may be provided on the apparatus 1102 to enable application software 1108 to be executed on the device.

Computer executable instructions may be provided using any computer-readable media that are accessible by the computing apparatus 1102. Computer-readable media may include, for example, computer storage media such as a memory 1110 and communications media. Computer storage media, such as the memory 1110, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus.

In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1110) is shown within the computing apparatus 1102, it will be appreciated by a person skilled in the art that the storage may be distributed or located remotely and accessed via a network or other communication link (e.g., using a communication interface 1112).

The computing apparatus 1102 may comprise an input/output controller 1114 configured to output information to one or more output devices 1116, for example a display or a speaker, which may be separate from or integral to the electronic device. The input/output controller 1114 may also be configured to receive and process an input from one or more input devices 1118, for example, a keyboard, a microphone, or a touchpad. In one embodiment, the output device 1116 may also act as the input device. An example of such a device may be a touch sensitive display. The input/output controller 1114 may also output data to devices other than the output device, e.g., a locally connected printing device. In some embodiments, a user may provide input to the input device(s) 1118 and/or receive output from the output device(s) 1116.

The functionality described herein can be performed, at least in part, by one or more hardware logic components. According to an embodiment, the computing apparatus 1102 is configured by the program code when executed by the processor 1104 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example computer system comprises: at least one processor; and at least one memory comprising computer program code, the at least one memory and the computer program code configured to, with the at least one processor, cause the at least one processor to: obtain third-party validation data describing total retail sales completed using a plurality of payment types within the geographic area during the selected time-period, wherein the third-party validation data is unbiased: calculate a regression coefficient defining a relationship between the transaction data and the validation data using regression analysis on the transaction data and the third-party validation data: filter the transaction data for sector-specific transaction data describing total retail sales within a sector selected from the plurality of sectors: estimate total retail sales for the selected sector using the sector-specific transaction data, the regression coefficient and a sector-specific constant in an absence of third-party validation data for the selected sector, the sector-specific constant representing a proportion of sector-specific sales relative to total retail sales for the plurality of sectors; and update the transaction data in the data storage device with the estimated total retail sales for the selected sector, wherein the bias associated with the single payment type is eliminated from the updated transaction data for the selected sector.

One or more exemplary non-transitory computer readable storage media comprise computer-executable instructions for eliminating bias from sector-specific credit-related transaction data by a biased data manager that, upon execution by a processor, cause the processor to at least: obtaining transaction data describing total retail sales completed using a single payment type across a plurality of sectors within a geographic area during a selected time-period, the transaction data including bias associated with the single payment type: obtaining validation data describing total retail sales completed using a plurality of payment types within the geographic area during the selected time-period from a third-party, wherein the third-party validation data is unbiased: calculating a regression coefficient defining a relationship between the transaction data and the validation data using regression analysis on the transaction data and the validation data: filtering the transaction data for sector-specific transaction data describing total retail sales within a sector selected from the plurality of sectors: eliminating the bias from the sector-specific transaction data using the regression coefficient and a sector-specific constant representing a proportion of sector-specific sales relative to total retail sales for the plurality of sectors in an absence of sector-specific validation data; and generating, via a user interface device, a graphical representation including the sector-specific transaction data, the sector-specific transaction data comprising estimated total retail sales completed using the plurality of payment types for the selected sector, wherein the bias associated with the single payment type is eliminated from the sector-specific transaction data.

In some examples, the system provides a novel approach to remove any bias in retail credit card transaction data for individual sectors by using the sectors where third-party validation data is available, train a regression on those sectors and use some of the regression characteristics of that equation (e.g. the slope and constant) to define the bias correction relationship for all other sectors. In other words, the system de-biases credit card transaction data for one or more retail sectors where third-party validation data is unavailable.

In an example scenario, the system takes government data, such as data from a census or survey, where (y)=time series of data (total sales per month for all sectors (“total retail”) for several years) for a country. The system gets credit card sales data x for total retail (using cc transaction data) for the same time series, for the same types of industries. The system performs a regression analysis to calculate slope m and a constant c values for the selected region, time-period, and/or sectors. The system filters the credit card sales data x time series of data from a credit card provider and a particular sector. The system gets a new sector-specific constant (scaled constant) c′ by scaling down. The system calculates y′, which is the non-biased sales for the particular sector. The system sends the data to one or more users (clients), updates transaction data and/or generates a UI for presenting the updated (de-biased) transaction data to the user(s). The de-biased data is used for generating future predictions (forecasting), recording updates to the transaction data for one or more geographic regions and/or one or more time-periods. The updated transaction data in other examples is output directly to the user as a notification, email, graph, report, chart, map, etc. In some examples, the updated transaction data for multiple countries, states, regions, territories, or other areas are combined into an aggregated summarization report or other graphical representation presenting retail data trends and summarized retail sector-specific data to a user. In other examples, updated transaction data for a geographic area during two or more different time-periods is aggregated together into a summarization report or other graphical representation providing retail data trends or other sector-specific time series transaction data to the user.

Alternatively, or in addition to the other examples described herein, examples include any combination of the following:
generate a graphical representation including the sector-specific transaction data via the user interface device, the sector-specific transaction data comprising estimated total retail sales for the selected sector;
train a regression model using the set of regression coefficients;
analyze the transaction data for each sector in the plurality of sectors by the trained regression model, wherein the trained regression model generates de-biased total sales data for each sector in the plurality of sectors using the transaction data in an absence of third-party validation data:
generate sector-specific future retail sales forecasts using predictive modeling on the updated transaction data for the selected sector;
present the updated transaction data to a user via a user interface device, wherein the updated transaction data includes de-biased total sales data for the selected sector within the geographic area during the selected time-period, wherein the geographic area comprises at least one of a country, state, territory, county, parish, and city;
wherein the single payment type comprises at least one of a credit card payment type and a debit card payment type;
filter the transaction data for second sector-specific transaction data describing total retail sales within a second selected sector from the plurality of sectors;
estimate total retail sales for the second selected sector using the second sector-specific transaction data, the regression coefficient and a second sector-specific constant representing a proportion of sector-specific sales for the second selected sector relative to the total retail sales for the plurality of sectors, wherein the estimated total retail sales for the second sector represents an estimate of sector-specific sales completed using the plurality of payment types;
obtaining transaction data describing total retail sales completed using a single payment type across a plurality of sectors within a geographic area during a selected time-period, the transaction data including bias associated with the single payment type;
obtaining validation data describing total retail sales completed using a plurality of payment types within the geographic area during the selected time-period from a third-party, wherein the third-party validation data is unbiased;
calculating a regression coefficient defining a relationship between the transaction data and the validation data using regression analysis on the transaction data and the validation data;
filtering the transaction data for sector-specific transaction data describing total retail sales within a sector selected from the plurality of sectors;
eliminating the bias from the sector-specific transaction data using the regression coefficient and a sector-specific constant representing a proportion of sector-specific sales relative to total retail sales for the plurality of sectors in an absence of sector-specific validation data;
generating, via a user interface device, a graphical representation including the sector-specific transaction data, the sector-specific transaction data comprising estimated total retail sales completed using the plurality of payment types for the selected sector, wherein the bias associated with the single payment type is eliminated from the sector-specific transaction data;
updating the transaction data within a database using the sector-specific transaction data, the sector specific transaction data including an estimated total retail sales for the selected sector corrected for bias;
training a regression model using the set of regression coefficients;
analyzing the transaction data for each sector in the plurality of sectors by the trained regression model, wherein the trained regression model generates de-biased total sales data for each sector in the plurality of sectors using the transaction data in an absence of third-party validation data;
generating sector-specific future retail sales forecasts using predictive modeling on the updated transaction data for the selected sector;
presenting the updated transaction data to a user via a user interface device, wherein the updated transaction data includes de-biased total sales data for the selected sector within the geographic area during the selected time-period, wherein the geographic area comprises at least one of a country, state, territory, county, parish, and city;
filtering the transaction data for second sector-specific transaction data describing total retail sales within a second selected sector selected from the plurality of sectors;
eliminating the bias from the second sector-specific transaction data using the trained regression model, the regression coefficient and a second sector-specific constant representing a proportion of sector-specific sales for the second sector relative to total retail sales for the plurality of sectors in an absence of sector-specific validation data;
obtaining credit-related transaction data describing total retail sales completed using a credit-related payment type across a plurality of sectors within a geographic area during a selected time-period, the transaction data including bias associated with the credit-related payment type;
obtaining third-party validation data describing total retail sales completed using a plurality of payment types within the geographic area during the selected time-period, the plurality of payment types including the credit-related payment type and non-credit payment types, wherein the third-party validation data is unbiased;
filtering the transaction data for sector-specific transaction data describing total retail sales within a sector selected from the plurality of sectors;
estimating total retail sales associated with the plurality of payment types for the selected sector using the sector-specific transaction data, the regression coefficient, and a sector-specific constant in an absence of third-party validation data for the selected sector, the sector-specific constant representing a proportion of sector-specific sales relative to total retail sales for the plurality of sectors; and
updating the transaction data within a database using the estimated total retail sales for the selected sector to eliminate the bias from the transaction data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It is understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for obtaining third-party validation data describing total retail sales completed using a plurality of payment types within the geographic area during the selected time-period: exemplary means for calculating a regression coefficient defining a relationship between the transaction data and the validation data using regression analysis on the transaction data and the third-party validation data: exemplary means for filtering the transaction data for sector-specific transaction data describing total retail sales within a sector selected from the plurality of sectors: exemplary means for estimating total retail sales for the selected sector using the sector-specific transaction data, the regression coefficient and a sector-specific constant in an absence of third-party validation data for the selected sector; and exemplary means for updating the transaction data in the data storage device with the estimated total retail sales for the selected sector.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for modeling retail sector spend data, the system comprising:
a data storage device storing transaction data describing total retail sales completed using a single payment type across a plurality of sectors within a geographic area during a selected time-period, the transaction data including bias associated with the single payment type; and
a computer-readable medium storing instructions that are operative upon execution by a processor to:
obtain third-party validation data describing total retail sales completed using a plurality of payment types within the geographic area during the selected time-period, wherein the third-party validation data is unbiased;
calculate a regression coefficient defining a relationship between the transaction data and the validation data using regression analysis on the transaction data and the third-party validation data;
filter the transaction data for sector-specific transaction data describing total retail sales within a sector selected from the plurality of sectors;
estimate total retail sales for the selected sector using the sector-specific transaction data, the regression coefficient, and a sector-specific constant in an absence of third-party validation data for the selected sector, the sector-specific constant representing a proportion of sector-specific sales relative to total retail sales for the plurality of sectors; and
update the transaction data in the data storage device with the estimated total retail sales for the selected sector, wherein the bias associated with the single payment type is eliminated from the updated transaction data for the selected sector.

2. The system of claim 1, further comprising:
a user interface device, wherein the instructions are further operative to:
generate a graphical representation including the sector-specific transaction data via the user interface device, the sector-specific transaction data comprising estimated total retail sales for the selected sector.

3. The system of claim 1, wherein the instructions are further operative to:
analyze the transaction data for each sector in the plurality of sectors by a trained regression model, wherein the trained regression model generates de-biased total sales data for each sector in the plurality of sectors using the transaction data in an absence of third-party validation data.

4. The system of claim 1, wherein the instructions are further operative to:
generate sector-specific future retail sales forecasts using predictive modeling on the updated transaction data for the selected sector.

5. The system of claim 1, wherein the instructions are further operative to:
present the updated transaction data to a user via a user interface device, wherein the updated transaction data includes de-biased total sales data for the selected sector within the geographic area during the selected time-period, wherein the geographic area comprises at least one of a country, state, territory, county, parish, and city.

6. The system of claim 1, wherein the single payment type comprises at least one of a credit card payment type and a debit card payment type.

7. The system of claim 1, wherein the selected sector is a first selected sector, wherein the sector-specific constant is a first sector-specific constant, wherein the instructions are further operative to:
filter the transaction data for second sector-specific transaction data describing total retail sales within a second selected sector from the plurality of sectors; and
estimate total retail sales for the second selected sector using the second sector-specific transaction data, the regression coefficient and a second sector-specific constant representing a proportion of sector-specific sales for the second selected sector relative to the total retail sales for the plurality of sectors, wherein the estimated total retail sales for the second sector represents an estimate of sector-specific sales completed using the plurality of payment types.

8. A method for modeling retail sector spend data, the method comprising:
obtaining transaction data describing total retail sales completed using a single payment type across a plurality of sectors within a geographic area during a selected time-period, the transaction data including bias associated with the single payment type;
obtaining validation data describing total retail sales completed using a plurality of payment types within the geographic area during the selected time-period from a third-party, wherein the validation data is unbiased;
calculating a regression coefficient defining a relationship between the transaction data and the validation data using regression analysis on the transaction data and the validation data;
filtering the transaction data for sector-specific transaction data describing total retail sales within a sector selected from the plurality of sectors;
eliminating the bias from the sector-specific transaction data using the regression coefficient and a sector-specific constant representing a proportion of sector-specific sales relative to total retail sales for the plurality of sectors in an absence of sector-specific validation data; and
generating, via a user interface device, a graphical representation including the sector-specific transaction data, the sector-specific transaction data comprising estimated total retail sales completed using the plurality of payment types for the selected sector, wherein the bias associated with the single payment type is eliminated from the sector-specific transaction data.

9. The method of claim 8, further comprising:
updating the transaction data within a database using the sector-specific transaction data, including an estimated total retail sales for the selected sector corrected for bias.

10. The method of claim 8, further comprising:
analyzing the transaction data for each sector in the plurality of sectors by a trained regression model, wherein the trained regression model generates de-biased total sales data for each sector in the plurality of sectors using the transaction data in an absence of third-party validation data.

11. The method of claim 8, further comprising:
generating sector-specific future retail sales forecasts using predictive modeling on updated transaction data for the selected sector.

12. The method of claim 8, further comprising:
presenting updated transaction data to a user via a user interface device, wherein the updated transaction data includes de-biased total sales data for the selected sector within the geographic area during the selected time-period, wherein the geographic area comprises at least one of a country, state, territory, county, parish, and city.

13. The method of claim 8, wherein the single payment type comprises at least one of a credit card payment type and a debit card payment type.

14. The method of claim 8, wherein the selected sector is a first selected sector, wherein the sector-specific transaction data is first sector-specific transaction data, and further comprising:
filtering the transaction data for second sector-specific transaction data describing total retail sales within a second selected sector selected from the plurality of sectors; and
eliminating the bias from the second sector-specific transaction data using a trained regression model, the regression coefficient and a second sector-specific constant representing a proportion of sector-specific sales for the second sector relative to total retail sales for the plurality of sectors in an absence of sector-specific validation data.

15. One or more computer storage devices having computer-executable instructions stored thereon, which, upon execution by a computer, cause the computer to perform operations comprising:
obtaining credit-related transaction data describing total retail sales completed using a credit-related payment type across a plurality of sectors within a geographic area during a selected time-period, the transaction data including bias associated with the credit-related payment type;
obtaining third-party validation data describing total retail sales completed using a plurality of payment types within the geographic area during the selected time-period, the plurality of payment types including the credit-related payment type and non-credit payment types, wherein the third-party validation data is unbiased;
calculating a regression coefficient defining a relationship between the transaction data and the validation data using regression analysis:
filtering the transaction data for sector-specific transaction data describing total retail sales within a sector selected from the plurality of sectors;
estimating total retail sales associated with the plurality of payment types for the selected sector using the sector-specific transaction data, the regression coefficient, and a sector-specific constant in an absence of third-party validation data for the selected sector, the sector-specific constant representing a proportion of sector-specific sales relative to total retail sales for the plurality of sectors; and
updating the transaction data within a database using the estimated total retail sales for the selected sector to eliminate the bias from the transaction data.

16. The one or more computer storage devices of claim 15, wherein the operations further comprise:
generating a graphical representation including the sector-specific transaction data via a user interface device, the sector-specific transaction data comprising estimated total retail sales for the selected sector.

17. The one or more computer storage devices of claim 15, wherein the operations further comprise:
analyzing the transaction data for each sector in the plurality of sectors by a trained regression model, wherein the trained regression model generates de-biased total sales data for each sector in the plurality of sectors using the transaction data in an absence of third-party validation data.

18. The one or more computer storage devices of claim 15, wherein the operations further comprise:
generating a sector-specific future retail sales forecast using predictive modeling on the updated transaction data for the selected sector.

19. The one or more computer storage devices of claim 15, wherein the operations further comprise:
presenting the updated transaction data to a user via a user interface device, wherein the updated transaction data includes de-biased total sales data for the geographic area, wherein the geographic area comprises at least one of a country, state, territory, county, parish, and city.

20. The one or more computer storage devices of claim 15, wherein the operations further comprise:
filtering the transaction data for second sector-specific transaction data describing total retail sales within a second selected sector from the plurality of sectors; and
estimating total retail sales associated with the plurality of payment types for the second selected sector using the second sector-specific transaction data, the regression coefficient and a second sector-specific constant in an absence of third-party validation data for the second selected sector.
